(19) United States
(12) Patent Application Publication
(10) Pub. No.: US 2016/0230018 A1
(43) Pub. Date: Aug. 11, 2016

(54) COMPOSITION, MARKING AND KIT OF PARTS FOR FORMING A MARKING, SUCH AS A ROAD MARKING

(71) Applicant: LKF Materials A/S, Rudkøbing (DK)

(72) Inventor: Anders Michael Fage-Pedersen, Svendborg (DK)

(73) Assignee: LKF Materials A/S, Rudkøbing (DK)

(21) Appl. No.: 15/019,854

(22) Filed: Feb. 9, 2016

(30) Foreign Application Priority Data
Feb. 11, 2015 (EP) 15154662.9

(51) Int. Cl. C09D 5/33; E01F 9/518; E01F 9/524

(52) U.S. Cl. CPC C09D 5/004; E01F 9/524; E01F 9/518

(57) ABSTRACT

The disclosure relates to a composition adapted to be applied to a surface (2) to form a marking (1), wherein the composition comprises a base composition (3), and coated glass beads (4), wherein the coated glass beads are mixed with the base composition (3), wherein the coated glass beads (4) are coated with a non-translucent coating material (8) which coating material, when the composition has been applied to a surface to form a marking, is adapted to be worn off at any exposed portion of the glass bead thereby allowing light to enter into the glass bead (6) at said exposed worn off portion and which coating material (8) is adapted to form a retro-reflective coating (8) reflecting light which has passed into the glass bead (6) to be reflected back through the glass bead (6) and out through said exposed portion where the coating has been worn off. The disclosure also relates to a marking formed of said composition, to a kit of parts for forming a marking on a surface and to a marking formed of such a kit of parts.

### TECHNICAL FIELD

The invention relates to a composition adapted to be applied to a surface to form a marking. The invention also relates to a marking formed of said composition. The invention also relates to a kit of parts for forming a marking on a surface. The invention also relates to a marking formed of such a kit of parts. The inventions are especially applicable to road markings.

### BACKGROUND TECHNOLOGY

Road markings are used on roads for different purposes including visualising borders of the road and division of the road into separate lanes. It is therefore of importance that the road markings are visible also in low light conditions. To provide the markings with desired visibility, road markings are often retro-reflective and are thereby capable of reflecting light back to its source. In respect of road markings, the retro-reflective marking is capable of reflecting light from the vehicle's headlight back to the driver. Preferably the retro-reflective marking is capable of reflecting more light from a vehicle's headlight in a direction back towards the driver of the vehicle, compared to other directions.

It has been known for a long time to improve retro-reflective properties of a road marking by adding glass beads to the road marking.

As early as in the 1950's it was disclosed to use glass beads in highway marking paint. GB 704,640 discloses to use glass beads in a paint. The paint comprises 38% pigments. It is also discussed to use 25-60% pigments. One example mentioned is water-dispersible titanium dioxide pigment.

However, to use such high amounts of pigments have today been proven to be too expensive. Moreover, many pigments, such as titanium dioxide have an environmental impact which makes it non-acceptable to use such high amounts of pigments.

To address the issue of improved retro-reflectivity, other approaches have been tried through-out the years.

It is known that glass particles having a refractive index approaching 2 will produce a high retro-reflectivity. However, such glass particles are comparably expensive.

It is known to provide glass beads with different coatings to increase the refractive index.

In KR20020017667 it is disclosed a method of producing glass beads having a high refractive index. The glass beads are adapted to be used for road markers. The high refractive index glass beads are produced by coating a low refractive index glass powder with high refractive index materials through sol-gel process, and thermal treating. The glass beads with a high refractive index (more than 1.8) are prepared by the following steps: coating low refractive index glass powder of soda lime composition, being 10-1000 micrometer in size, with a sol of high refractive material which is an organic metal selected form the group consisting of Ti, Ba and Pb or salt thereof through an impregnating process; drying at room temperature for coating high refractive index glass powder with a coating film; and thermal treating over a softening point of low refractive index glass to form a glass bead with a glass coating film.

In US 2011/0200789 A1 it is also disclosed a method of providing high refractive index glass beads. It is disclosed to provide a solid spherical core with one or more interference layer surrounding the core. The different layers are selected to have a difference in refractive index of 0.1 or more. Thereby light is reflected at interfaces between the different layers and the core. It is mentioned that suitable materials to use as coatings for the interference layers include inorganic materials to provide transparent coatings. Such coatings tend to make bright, highly retro-reflective articles. Included within the foregoing inorganic materials are inorganic oxides such as Ti0₂ (refractive index of 2.2-2.7) and Si0₂ (refractive index of 1.4-1.5) and inorganic sulphides such as ZnS (refractive index of 2.2). The foregoing materials can be applied using any of a variety of techniques. Other suitable materials having a relatively high refractive index include CdS, Ce0₂, Zr0₂, Bi₂0₃, ZnSe, WO₃, PbO, ZnO, Ta₂0₅, and others known to those skilled in the art. Other low refractive index materials suitable for use in the present invention include Al₂0₃, Bp₃, AlF₃, MgO, CaF₂, CeF₃, LiF, MgF₂ and Na₃AlF₆. In 2011/0200789 A1 it is disclosed to alternate layers of high refractive index with layers of high refractive index to produce a great number of interfaces with different refractive indexes.

However, road markings making use of such so-called high refractive index glass beads still requires significant amounts of pigments to provide the marking with the desired colouring of the marking. Moreover, the markings with the high refractive index glass beads also require significant amounts of pigments to provide the desired retro-reflectivity.

Thus, there is still a need to provide a new kind of technology that provides an even further improved retro-reflectivity relative to the pigment needed to produce this retro-reflectivity. Furthermore, as mentioned above, various ecological studies recommend minimizing the usage of various pigments such as TiO2.

### SUMMARY OF THE INVENTION

The above object has been achieved with a new technology. The technology makes use of glass beads which has been coated. The coated glass beads are used together with a base composition. The base composition may e.g. be paint, a thermoplastic or a cold plastic, preferably of the kinds defined in EN1871 entitled “Road marking materials—Physical properties”. The base composition may be adapted to be applied to a surface to form a marking. The base composition may alternatively be used to provide a pre-formed marking, such as a tape, preformed cold plastic or preformed thermoplastic marking, preferably of the kinds defined in EN1790 entitled “Road marking materials—Preformed road markings”.

The composition is adapted to be applied to a surface to form a marking, wherein the composition comprises a base composition, and coated glass beads, wherein the coated glass beads are mixed with the base composition.

The coated glass beads may be coated with a coating material, which, when the composition has been applied to a surface to form a marking, is adapted to be worn off at any exposed portion of the glass bead thereby allowing light to enter into the glass bead at said exposed worn off portion and which coating material is adapted to form a retro-reflective coating reflecting light which has passed into the glass bead to be reflected back through the glass bead and out through said exposed portion where the coating has been worn off. The coating material may e.g. comprise TiO₂. The coating material is provided in such an amount that it will provide a retro-reflective coating reflecting light that has passed into the glass bead. However, the coating material is provided in such an amount that before it is worn off, it will be essentially non-translucent. Thus, before the coating material has been worn off it will essentially not allow light to enter into the glass bead. Once the coating material has been worn of at any exposed portion, (and only thereafter) it will allow light to enter into the glass bead and thereafter will it provide it superior retro-reflective properties. It is recognised that there may be many different materials that may be used to provide this retro-reflectivity. Depending upon the choice of material, the amount of coating material will vary greatly. The coated glass beads allow light, which enters the glass bead, to be retro-reflected in the area of the interface of the glass and the coating, or in the coating, and, thus the retro-reflection does not rely on properties of the base composition. Thereby, the use of materials which enhances retro-reflection may be concentrated to the coating while minimised or even avoided in the base composition. Thereby it is possible to provide the desired retro-reflective properties with amounts of pigments being significantly lower than for the known prior art technologies.

To provide this excellent retro-reflectivity, it may be considered that the coating should be such that it, when coated on premix glass beads according to EN 1424 class A having a size within 180 and 600 μm and with the coated glass beads being provided in an amount of 30% by weight in a non-pigmented reference composition, will produce a reflectivity of at least 100 mcd/lux/m2 measured at a wear simulator turntable according to standard EN 13197 at traffic class P4. Traffic class P4 equates to 500.000 wheel passages in said standard.

As is shown in FIG. 3, the example in series 1 with non-coated glass beads provided according to EN 1424 class A having a size within 180 and 600 μm and with the coated glass beads being provided in an amount of 30% by weight in a non-pigmented reference composition results in an reflectivity which is significantly lower than 100 mcd/lux/m2.

Mixing of the coated glass beads with the base composition results in the coated beads being spread in the base composition, thereby providing efficient retro-reflection also when the marking is worn, such as, for example, in the case of a road marking being worn down by the wheels of passing vehicles and by the influence of ambient parameters such as wind, rain and sun. New coated glass beads will be exposed and the coating will be worn off from those newly exposed glass beads. It is also an advantage that the coating truly provides a colouring effect to the light reflected back. It is possible to provide a truly white retro-reflectivity or a yellow retro-reflectivity if so is desired.

The non-pigmented reference composition comprises in percent by weight, apart from said 30% by weight of coated glass beads, 13% resin, 13% sand, 41% dolomite, and 3% plasticiser.

The composition actually adapted to be applied to a surface to form a marking may comprise glass beads with a size between 180 and 600 micrometers. Preferably the glass beads are of class A according to EN 1423 and EN 1424, respectively.

The composition actually adapted to be applied to a surface to form a marking may comprise between 5-80% by weight of coated glass beads, preferably between 20-50%.

The coating material may comprise white or yellow pigments. The white pigments may comprise TiO₂ or ZnO. These pigments are useful since they provide retro-reflectivity and since they provide a white colour. In case it is desired to have a yellow marking the coating may e.g. comprise a blend of an equal amount of TiO2 and a yellow pigment, such as PY13.

The amount of coating material may be between 0.1% to 15% by weight of the glass of the coated glass beads, preferably between 0.1% to 10%, and most preferably between 1% to 10%. These amounts are especially, but not exclusively, suitable when TiO₂ is used as pigment. The pigment makes up about 50% of the coating and the remainder of the coating is a binder, such as a resin binder. Thus, it is considered that the amount of pigment, such as TiO₂, is between 0.05% to 8% by weight of the glass beads, preferably between 0.05% to 8% and most preferably between 0.5% to 5%.

The coating on the glass beads may be non-translucent.

The base composition comprises between 0-7%, preferably between 0-3% of TiO₂ or a blend of TiO2 and a yellow pigment, such as PY13. This way the marking as such will have a white colour or a yellow colour.

The base composition may be thermoplastic.

The composition may be supplied in granular or powder form and may be adapted to be heated to a molten state and to be applied to a surface in any desired form. This is a way of providing a composition often used for production of lane or side markers.

The marking may be formed into a pre-formed sheet of a thermoplastic road marking material, wherein the pre-formed sheet is adapted to be applied to a surface and to be heated to a partly molten state and to adhere to said surface. This is a way of providing a composition which is useful when comparably complex shapes of the marking is desired. It is e.g. useful when it is desired to have a marking shaped as a symbol. The symbol may e.g. be letters, arrows, bi-cycle symbols, and wheel chair symbols.

When using the composition to form a marking, the marking, may apart from coated glass beads mixed with the base composition, further comprise coated drop-on beads, wherein the composition comprising the base composition and the coated premix glass beads is adapted to be applied to a surface and the coated drop-on glass beads are adapted to thereafter be applied to the composition as drop-on beads,

wherein the coated drop-on glass beads are coated with a coating material which coating material is adapted to be worn off at any exposed portion of the glass beads thereby allowing light to enter into the glass beads at said exposed worn off portion and which coating material is adapted to form a retro-reflective coating reflecting light which has passed into the glass beads to be reflected back through the glass beads and out through said exposed portion where the coating has been worn off,

wherein the coating, when coated on drop-on glass beads according to EN 1423 class A having a size within 180 and 600 μm and with the coated glass beads being provided in an amount of 30% by weight in a non-pigmented reference composition, will produce a reflectivity of at least 100 mcd/lux/m2 measured at a wear simulator turntable according to EN 13197 at traffic class P4.

It may be noted that in the application of the actual marking, coated drop-on beads may be used together with conventional non-coated drop-on beads.

The composition may also be provided as a kit of parts for forming a marking on a surface, wherein the kit of parts comprises:

a base composition, and

coated drop-on glass beads,

wherein the base composition and coated drop-on glass beads are provided without being mixed with each other,

wherein the base composition is adapted to be applied to a surface and the coated glass beads are adapted to thereafter be applied to the base composition as drop-on beads,

wherein the coated glass beads are coated with a coating material which coating material is adapted to be worn off at any exposed portion of the glass beads thereby allowing light to enter into the glass beads at said exposed worn off portion and which coating material is adapted to form a retro-reflective coating reflecting light which has passed into the glass beads to be reflected back through the glass beads and out through said exposed portion where the coating has been worn off,

wherein the coating, when coated on drop-on glass beads according to EN 1423 class A having a size within 180 and 600 μm and with the coated glass beads being provided in an amount of 30% by weight in a non-pigmented reference composition, will produce a reflectivity of at least 100 mcd/lux/m2 measured at a wear simulator turntable according to EN 13197 at traffic class P4.

It may be noted that the composition provided as a kit of parts with a base composition and coated drop-on beads may refer to a system with the base composition being mixed with coated premix beads as discussed above. In this context it may especially be noted that the preferred embodiments of the composition with base composition and premix beads are applicable also for the kit of parts composition. In such a case the kit of parts may in one alternative be a kit of parts including a premix with the base composition and coated premix beads mixed as one part and the drop-on beads as a second part. Alternatively the kit of parts may be a base composition as a first part, the coated premix beads as a second part and the coated drop-on beads as a third part. Alternatively, the kit of parts may relate to a system with the base composition not being mixed with any coated premix beads or the kind discussed above.

The coated drop-on glass beads may be applied to a visible surface of the marking in an average amount of 200 to 600 grams per square metre of the visible surface. This is useful both for markings with and markings without any coated premix beads. It may also be noted that coated drop-on beads may also be used in combination with non-coated glass beads.

### BRIEF DESCRIPTION OF DRAWINGS

The invention will by way of example be described in more detail with reference to the appended schematic drawings, which shows a presently preferred embodiment of the invention.

FIGS. 1a-b show a marking according to an embodiment.

FIGS. 2a-b show a marking according to an embodiment.

FIG. 3 is a diagram illustrating experimental results.

FIG. 4 is a diagram illustrating experimental results.

### DETAILED DESCRIPTION

Embodiments will now be discussed with reference to the figures. The discussions are made for the sake of clarifying and exemplifying embodiments of the invention. The figures and details of the figures are schematically illustrated and not attempted to be drawn to scale.

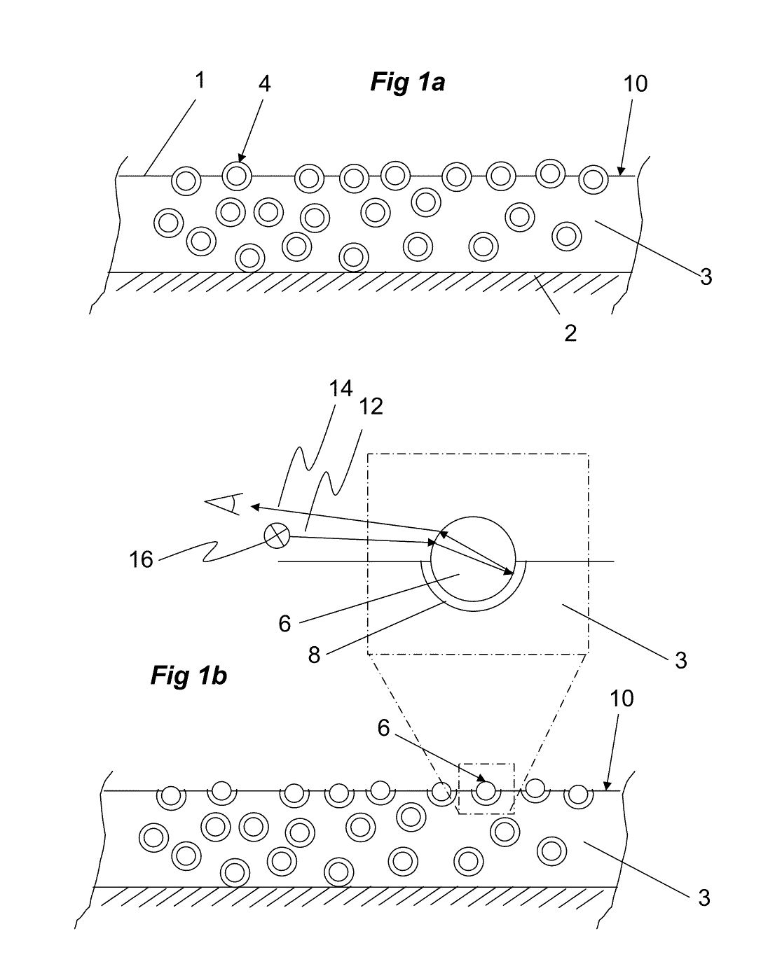

With reference to FIGS. 1a-b, an embodiment relating to a road marking comprising a base composition 3 and coated premix glass beads 4 will now be discussed. The road marking 1 is applied on a road surface 2, such as a road surface made of asphalt. The road marking 1 comprises coated glass beads 4, with a core of a glass bead 6 and a coating 8. It is noted that the coated glass beads 4 are homogenously mixed in with the base composition 3.

FIG. 1a illustrates the marking 1, as seen after the composition has been applied to the road surface 2 but before any wear has occurred. FIG. 1b shows the same road marking 1 after a certain amount of wear has occurred.

After initial wear of the marking 1, any coating at exposed portions of the coated glass beads 4 has been worn off. Exposed portions of the glass beads 4 are portions protruding from the top surface 10 of base composition 3 of the marking 1. Such exposed portions of the glass beads 4 are not embedded in the base composition 3 and are therefore not protected against wear. The wear may e.g. originate from the wheels of cars driving over the marking 1. The result of the wearing off of the coating is a local absence of the coating 8 which exposes the glass beads 6 and thereby permits light to enter into the glass bead 4 and be reflected in the remaining coating 8.

The inset of FIG. 1b illustrates how the light is retro-reflected from for example the head lights 16 of a vehicle, wherein arrow 12 illustrates a light path from the vehicle to the glass bead 4, and arrow 14 illustrates a light path of that light being retro-reflected towards the vehicle, such that the driver can see the marking 1.

As the marking 1 is worn further, new coated glass beads 4 will surface, the exposed coating 8 of those glass beads 4 will be worn off and the retro-reflective properties of the marking 1 will remain over time.

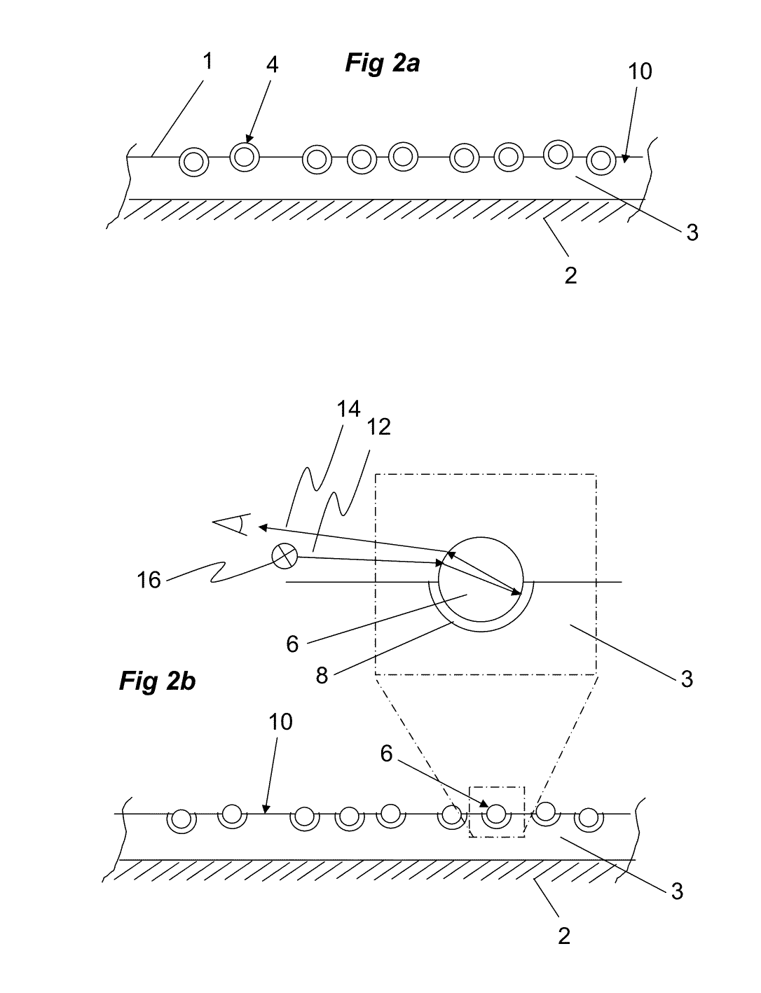

FIGS. 2a-b show an embodiment where coated drop-on beads 4 has been dropped on a base composition 3 once the base composition 3 has been applied to the road surface 2.

The road marking 1 is applied on a road surface 2. Before the base composition 3 has hardened or solidified coated drop-on beads 4 are dropped on top of the base composition 3 applied to the road surface 2. The drop-on beads 4 are applied to the marking 1 in an amount of 200-600 grams per square meter.

FIG. 2a illustrates the marking 1, as seen after the base composition 3 has been applied to the road surface 2 and the drop-on beads 4 have been dropped onto the marking 1, but before any wear has occurred. FIG. 2b shows the same road marking 1 after a certain amount of wear has occurred.

After initial wear of the marking 1, any coating at exposed portions of the coated glass beads 4 has been worn off. Exposed portions of the glass beads 4 are portions protruding from the top surface 10 of base composition 3 of the marking 1. Such exposed portions of the glass beads 4 are not embedded in the base composition 3 and are therefore not protected against wear. The wear may e.g. originate from the wheels of cars driving over the marking 1. The result of the wearing off of the coating is a local absence of the coating 8 which exposes the glass beads 6 and thereby permits light to enter into the glass bead 4 and be reflected in the remaining coating 8. The inset of FIG. 2b illustrates how the light is retro-reflected from for example the head lights 16 of a vehicle, wherein arrow 12 illustrates a light path from the vehicle to the glass bead 4, and arrow 14 illustrates a light path of that light being retro-reflected towards the vehicle, such that the driver can see the marking 1.

### Example, Preparation of Coated Glass Beads

Coated glass beads 4 may be prepared according to the following.

In this example the glass beads selected are commercially available e.g. from AllGlass under commercial name Pre-mix 600-180. They are produced in accordance with EN 1423 and EN 1424, they have a nominal size between 600-180 μm and are of Soda Lime Glass (class A).

In this example, the glass beads are coated with a total amount of coating of 4 grams of coating per 100 gram glass beads. The TiO₂ content in the coating is 62% (weight). Thus, the total amount of TiO₂ is 2.48 gram TiO₂ per 100 g beads.

The coating may be provided by any method considered appropriate. One example which is easily reproducible also in small scale production or in laboratory settings is disclosed below. Basically, the coating is poured over the beads in a pot and stirred until surface dry (approx. 30 min.). The beads have then been heated to approx. 80 degress celcius for approx. 30 min. for complete curing of the coating. This process have been repeated 4 times (4 layers with 1 gram coating per 100 gram beads) for better coverage.

The method includes the following steps:

1) Start with the binder (acrylic resin)

2) Add solvent (buthylacetat).

3) Add the rutile TiO₂.

4) Shear TiO₂ particles (breaking the TiO₂ agglomerates) and ensure good dispersion.

5) Control viscosity (to ensure good dispersion)

6) Mix the white paint and the hardener (aliphatic polyisocyanate) in the ratio 10:1

7) Mix glass beads and coating.

8) Stir until dry on surface (min. 30 minutes).

9) Drying process, complete curing of the coating (time depends on temperature—e.g. 30 min at 80 degrees C.).

10) Repeat coating procedure 4 times

If it is desired to provide the glass beads with a yellow coating, the binder and procedure may be the same as for the white version. In order to provide the yellow coating one may e.g. use a mixture, such as a 50/50 mixture, of TiO2 and yellow pigment (such as Benzidine Yellow GR).

Other mixtures may be chosen dependent upon the application in which the coated glass beads are to be used.

### Preparation of a Base Composition

In the description below an example of a base composition will be disclosed. This actual base composition is also used as the non-pigmented reference composition. In this table, suitable examples of the different components have been identified with their commercial trade names.

TABLE 1
Reference thermoplastic composition

| Component | % (weight) |
|---|---|
| Resin (e.g. Sylvatac RAZ100) | 13 |
| Sand (e.g. Kristall-Quarzsand G11T) | 13 |
| Dolomite (e.g. Microdol 200) | 41 |
| Coated Glass beads (conforming with EN 1424/1423) | 30 |
| 600-180 μm, class A | |
| Plasticizer (e.g. Castor Oil First Special Grade) | 3 |

The components are mixed and heated to between 180-200° C. They are stirred for homogenization.

### Examples for the Verification of Retro-Reflectivity

One composition was prepared according to table 1 with the coated glass beads being coated with the TiO₂ coating of 4 grams of coating per 100 gram glass beads with the TiO₂ content being 2.48 gram TiO₂ per 100 g glass beads.

Another composition was prepared in the same manner with the only difference that the glass beads was not coated.

In accordance with the reference test procedure, the thermoplastic compositions were heated and applied in a 3 mm thick layer on a test plate with a surface roughness according to class RG2 (according to EN 13197). The thus applied markings were subjected to a wear simulator turntable test according to EN 13197.

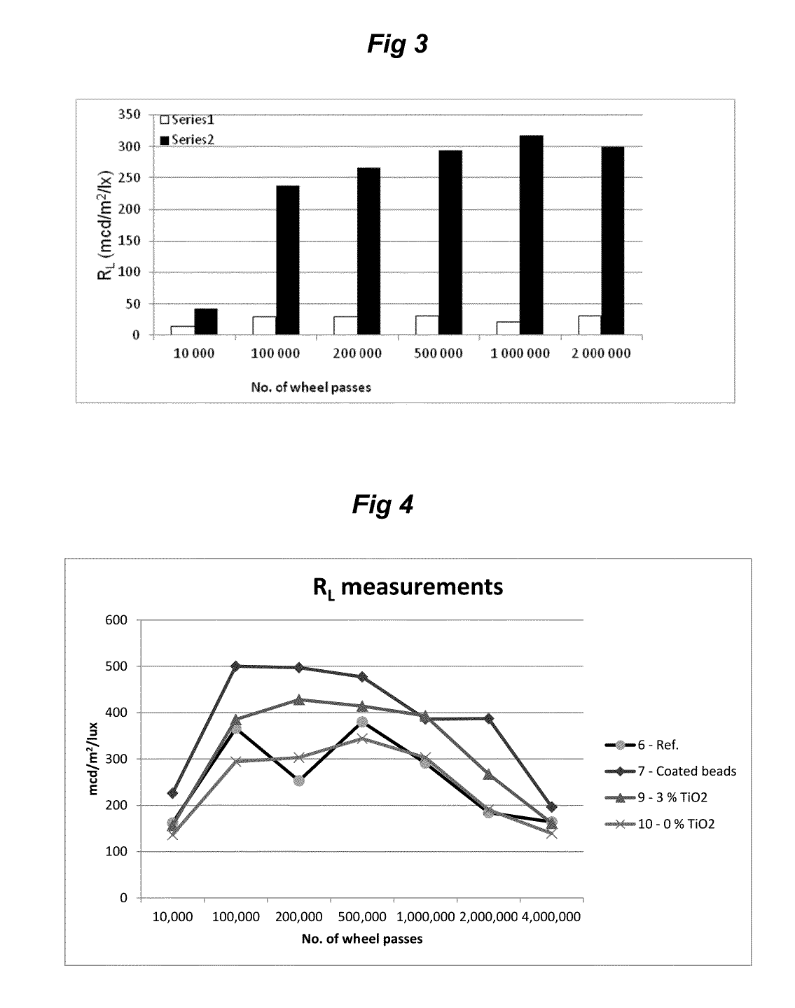

The retro-reflection, R_{L}, was measured according to the standard after certain number of wheel passes. The result of these measurements is shown in FIG. 3. The result for the composition with coated glass beads is shown in series 2 (the black bars) and the result for the composition with non-coated glass beads is shown in series 1 (white bars). It may be seen that the reference test procedure provides a significant difference for the coated glass beads and the non-coated glass beads.

In FIG. 4, the results of another comparative study are shown.

The composition in the test named series 6 is the following.

| Component | % (weight) |
|---|---|
| Resin (rosin ester) | 13 |
| White sand | 13 |
| Dolomite | 35 |
| Glass beads, premix 600-180 | 30 |
| Rutile TiO₂ | 6 |
| Plasticizer | 3 |

It may especially be noted that the glass beads are non-coated and that the base composition comprises 6% TiO₂.

The composition in series 7 is the same but with the glass beads being coated with TiO₂.

The composition in series 9 includes 1.5%+1.5% anatase and rutile TiO₂ with change in amount of TiO₂ balanced by the amount of dolomite being increased from 35% to 38%.

The composition in series 10 does not include any TiO₂ in the base composition and the amount of dolomite has been further increased to 41%.

It may be noted from the results shown in FIG. 4, that it is possible to provide a significant improvement in the retro-reflectivity with a small amount of additional TiO₂ (compare the results for series 6 and 7). The coated glass beads add less than 1% of TiO₂. It may also be noted that it is possible to provide an improved retro-reflectivity with an amount of TiO₂ being lower than for the reference (series 6) (see the results of series 9 with 3% TiO₂ in the base composition with coated glass beads). It may from the results of series 10 be noted that the invention alternatively provides a possibility to accomplish the same retro-reflectivity with less than 1% of TiO₂ as accomplished with conventional technology using as much as 6% TiO₂. Thus, the inventive technology offers a significant improvement over the prior art.

It may be noted that the compositions actually used as markings may be varied in numerous ways. As mentioned above, the base composition may be any thermoplastic, cold plastic or paint suitable for use as a road marking. Such compositions are defined and discussed in EN1871 entitled “Road marking materials—Physical properties”. The amount of coated glass beads may be varied depending on the application and the desired retro-reflectivity. The amount and kind of pigment used in the coating may also be varied depending on the application and the desired retro-reflectivity.

1. A composition adapted to be applied to a surface to form a marking, wherein the composition comprises
a base composition, and
coated glass beads,
wherein the coated glass beads are mixed with the base composition,
wherein the coated glass beads are coated with a coating material which coating material, when the composition has been applied to a surface to form a marking, is adapted to be worn off at any exposed portion of the glass bead thereby allowing light to enter into the glass bead at said exposed worn off portion and which coating material is adapted to form a retro-reflective coating reflecting light which has passed into the glass bead to be reflected back through the glass bead and out through said exposed portion where the coating has been worn off,
wherein the coating is non-translucent, and
wherein the coating, when coated on premix glass beads according to EN1424 class A having a size within 180 and 600 μm and with the coated glass beads being provided in an amount of 30% by weight in a non-pigmented reference composition, will produce a reflectivity of at least 100 mcd/lux/m2 measured at a wear simulator turntable according to EN 13197 at traffic class P4.

2. A composition according to claim 1, wherein the non-pigmented reference composition comprises in percent by weight, apart from said 30% by weight of coated glass beads,
13% resin,
13% sand
41% dolomite, and
3% plasticiser.

3. A composition according to claim 1, wherein the composition adapted to be applied to a surface to form a marking comprises between 5-80% by weight of coated glass beads, preferably between 20-50%.

4. A composition according to claim 1, wherein the coating material comprises white or yellow pigments.

5. A composition according to claim 1, wherein the amount of coating material is between 0.1% to 15% by weight of the glass of the coated glass beads, preferably between 0.1% to 10%, and most preferably between 1% to 10%.

6. A composition according to claim 1, wherein the base composition comprises between 0-7%, preferably between 0-3% of TiO₂.

7. A composition according to claim 1, wherein the base composition is thermoplastic.

8. A marking formed of a composition according to claim 1, wherein the marking, apart from coated glass beads mixed with the base composition, further comprises coated drop-on beads, wherein the composition comprising the base composition and the coated premix glass beads is adapted to be applied to a surface and the coated drop-on glass beads are adapted to thereafter be applied to the composition as drop-on beads,
wherein the coated drop-on glass beads are coated with a coating material which coating material is adapted to be worn off at any exposed portion of the glass beads thereby allowing light to enter into the glass beads at said exposed worn off portion and which coating material is adapted to form a retro-reflective coating reflecting light which has passed into the glass beads to be reflected back through the glass beads and out through said exposed portion where the coating has been worn off,
wherein the coating, when coated on drop-on glass beads according to EN 1423 class A having a size within 180 and 600 μm and with the coated glass beads being provided in an amount of 30% by weight in a non-pigmented reference composition, will produce a reflectivity of at least 100 mcd/lux/m2 measured at a wear simulator turntable according to EN 13197 at traffic class P4.

9. A kit of parts for forming a marking on a surface, wherein the kit of parts comprises:
a base composition, and
coated drop-on glass beads,
wherein the base composition and coated drop-on glass beads are provided without being mixed with each other,
wherein the base composition is adapted to be applied to a surface and the coated glass beads are adapted to thereafter be applied to the base composition as drop-on beads,
wherein the coated glass beads are coated with a coating material which coating material is adapted to be worn off at any exposed portion of the glass beads thereby allowing light to enter into the glass beads at said exposed worn off portion and which coating material is adapted to form a retro-reflective coating reflecting light which has passed into the glass beads to be reflected back through the glass beads and out through said exposed portion where the coating has been worn off,
wherein the coating, when coated on drop-on glass beads according to EN 1423 class A having a size within 180 and 600 μm and with the coated glass beads being provided in an amount of 30% by weight in a non-pigmented reference composition, will produce a reflectivity of at least 100 mcd/lux/m2 measured at a wear simulator turntable according to EN 13197 at traffic class P4.

10. A marking according to claim 8, wherein the coated drop-on glass beads are applied to a visible surface of the marking in an average amount of 200 to 600 grams per square metre of the visible surface.

11. A marking formed of the kit of parts of claim 9, wherein the coated drop-on glass beads are applied to a visible surface of the marking in an average amount of 200 to 600 grams per square metre of the visible surface.

12. A marking according to claim 8, composed of a base composition and coated drop-on glass beads, the coated glass beads provided in an amount of 5-90% by weight.

13. A marking formed of the kit of parts of claim 9, composed of a base composition and coated drop-on glass beads, the coated glass beads provided in an amount of 5-90% by weight.
